(19) United States
(12) Patent Application Publication
(10) Pub. No.: US 2007/0282793 A1
(43) Pub. Date: Dec. 6, 2007

(54) Computer desktop sharing

(76) Inventors: Kenneth D. Majors, Lake Oswego, OR (US); Scott Deboy, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/809,869

(22) Filed: Jun. 1, 2007

Related U.S. Application Data
(60) Provisional application No. 60/809,920, filed on Jun. 1, 2006.

(51) Int. Cl. G06F 17/30

(52) U.S. Cl. 707/2

(57) ABSTRACT

A desktop sharing system.

### CROSS-REFERENCE TO RELATED APPLICATIONS

This application claims the benefit of U.S. Provisional App. No. 60/809,920, filed Jun. 1, 2006.

### BACKGROUND OF THE INVENTION

The present invention relates to desktop sharing.

The user of a computer tends to view documents on the screen, otherwise generally referred to as the desktop of the computer. For a computer user to share the document with other users, traditionally the two users would view the same screen while being at the same physical location. While such sharing is convenient when both users are in the same vicinity, it is problematic when both users are at remote locations.

To facilitate the sharing of a computer desktop between remote users, both users may connect to the same computer though a network connection in some manner and share the desktop on one of the computers. For example, a first user of a first computer may have a desktop on his computer, while a second user connects to the first computer though a network connection and views a copy of the desktop of the first user in a window on his desktop. In this manner, both users may view the same document at the same time. In some cases the users may discuss the documents using an audio stream. In addition, mechanisms may be used to determine who controls what content is viewed on the desktop of the first computer.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates desktop sharing.

FIG. 2 illustrates sharing of an entire desktop.

FIG. 3 illustrates multiple frame layers.

### DETAILED DESCRIPTION OF PREFERRED EMBODIMENT

In a computer based conferencing environment, there may be multiple users sharing information and discussing items using a joint audio conferencing, joint video conferencing, and/or joint document sharing system. The audio conferencing enables multiple users to simultaneously discuss things in an effective manner. The video conferencing enables multiple users to simultaneously view each other which is helpful to convey ideas to one another. The joint document sharing system permits different users to simultaneously view electronic documents that are being edited or otherwise being modified.

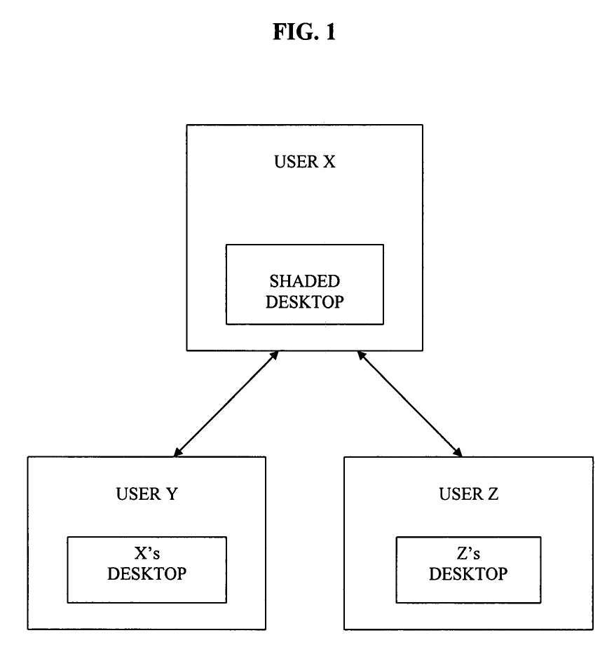

Referring to FIG. 1, in many cases a user in a conference has a desktop (or otherwise a screen image) on his computer that he desire to share with other users. In this manner, multiple viewers may observe the changes made to the desktop by the user. For example, the user may show others how to draw a picture, present a power point presentation, illustrate changes made to documents, or otherwise illustrate useful information. Typically, the user of the desktop being shared has control over the desktop upon moving the mouse or otherwise desiring to interact with the desktop. The control over the desktop may be passed to another user, as desired, using any suitable mechanism. Accordingly, the user may present the desktop to others to view, or otherwise share the use of the desktop among others while permitting them to view the desktop.

While the presentation and/or sharing of the desktop is especially beneficial for users of the system that are present, it has limitations when other users want to view only one or more portions of what is being presented. By being selective on the selection of a window, multiple windows, regions of one or more windows, or regions of the desktop that the user want to share, the user can keep private from other users the regions of the desktop that the user does not want to share.

In other configurations, the same desktop may be shared among a plurality of different groups. For example, a first window of the desktop may be shared with a first group of users, and a second window of the desktop may be shared with a second group of users. This separation of the portions of the desktop being shared may include any two portions defined in any manner of the desktop, either separate or overlapping. In many cases, the conferencing system includes groups of users, such as friends akin to instant messaging systems. By way of example, the different portions may be shared consistent with different groups. In this manner user A may share a first part of the desktop with users B, C, D, and E; and user A may share a different part of the desktop with users C, F, G, and H.

In this manner, multiple viewers may view the same content that is on the desktop. Each of the user's are preferably networked together using any type of computer network, such as a LAN, WAN, or Internet. User X has a computer desktop that user x may manipulate. User Y and user Z interconnect to user x's computer and obtain an image of the desktop on user x's computer that is periodically updated in some manner. Control over which user controls the desktop may be selected in any suitable manner.

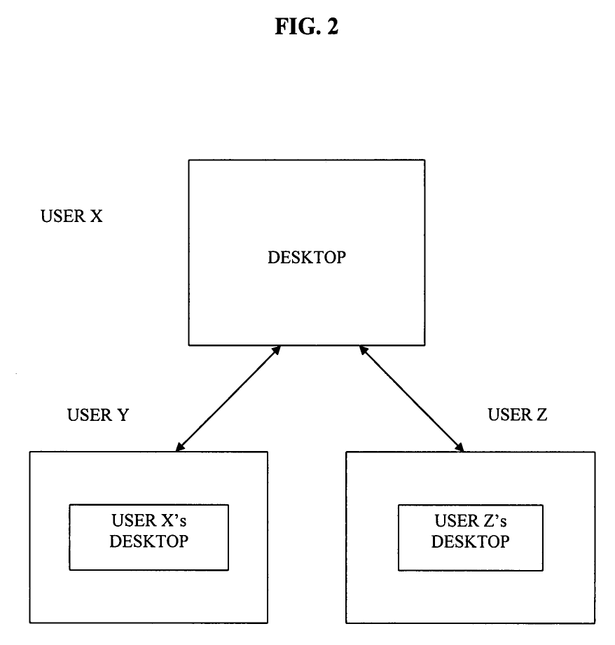

Referring to FIG. 2, the preferred system permits the sharing of the entire computer desktop of the user x's desktop. The sharing is preferably not dependent on any particular window within the desktop or a window of an application. By sharing the entire desktop, the user x may simultaneously share any document within any window on the computer, in the case of user interfaces that include separate windows. To view the document, the user typically needs appropriate viewer software, such as Microsoft Word to open a Word file. The user can likewise open multiple different windows and/or present multiple different items at once on the desktop. The user Y and user Z may view the entire desktop of user x within a window on their computer. Alternatively, the user Y and/or Z may view the entire desktop of user x as their entire desktop in the same manner as user X.

In other configurations, the system may permit the user to select a region of his desktop that is shared independent of the particular windows on the desktop. In this manner, the windows may be within the selected region or may extend past the selected region, with only those portions in the selected region being visible. Also, the user may select more than one window that will simultaneously be shared with others, with the other regions of the desktop not being shared. Likewise, the user may select a combination of one or more windows together with one or more regions of the desktop to be shared with others.

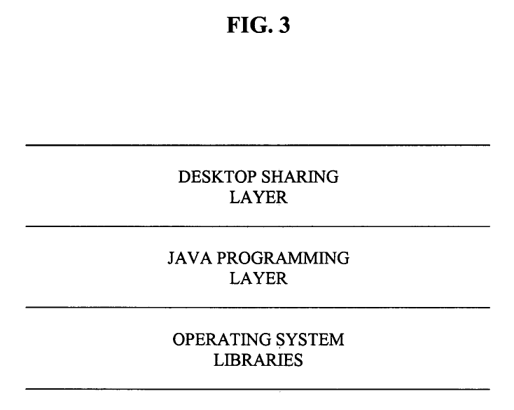

Referring to FIG. 3, in order to more effectively share the desktop user x preferably uses software that includes libraries that link to the particular operating system for capturing the desktop image. For example, in Windows the library may be included in the GDI libraries. For example, in Apple OSX and other operating systems the library may be different. Depending on the particular implementation, an intermediate software layer may be used, such as Java or Flash, to request the screen capture of the desktop from the operating system library. If the intermediate software layer is not included, typically a separate program layer would be included as a desktop sharing layer with calls to the libraries of the operating system. The desktop sharing layer may make calls to the intermediate software layer, which in turn, makes calls to the operating system layer. On top of the operating system libraries, intermediate programming layer, and/or desktop sharing layer may be used to periodically capture the desktop for sharing with other users. The calls to the libraries of the operating system are different for each operating system.

In order to more effectively share the desktop of the user, it is desirable to permit the user to show comments, text, and marks over the top of any image on the desktop. For example, a user may desire to draw a circle around something of interest or otherwise draw on the desktop. A set of tools shown on the desktop may be used for drawing on the desktop, such as for example, free form select, box select, eraser, fill with color, color selector, magnification, pencil, brush, airbrush, text, line, curve, rectangle, polygon, ellipse, rounded rectangle, and color selections. In this manner, the user may make notations or other marks on a layer that is logically overlaid on the underlying desktop content. The layer over the desktop layer upon which is drawn or otherwise overlaid on the underlying desktop layer, is likewise shared with the other users so that they see the same content. Both layers may be captured as a composite image and provided to other users, or each of the layers may be transmitted separately and composed by the receiving user.

It may be observed that by including the sharing of the entire desktop, the user is relieved from having to determine how to mark up a drawing or other content within a particular window operating a particular program, such as Autocad or Word, since the preferred embodiment is detached from the particular window or application. In addition, this extends the ability to have general whiteboard sharing, which is detached from the underlying content of the desktop.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A conferencing system:
(a) a conferencing server enabling video and audio interconnectivity between different users;
(b) a first computer accessing said conferencing server;
(c) a second computer accessing said conferencing server;
(d) at least one of said conferencing server, said first computer, and said second computer displaying a desktop on an associated display;
(e) at least one of said conferencing server, said first computer, and said second computer sharing with to one of said first computer and said second computer said desktop for viewing what is being displayed on said display;
(f) the portion of said desktop being shared is selected by the user of said desktop being shared.

2. The system of claim 1 wherein said selected portion is the entire said desktop being shared.

3. The system of claim 1 wherein said selected portion is consistent with a single window of said desktop being shared.

4. The system of claim 1 wherein said selected portion is consistent with a plurality of windows of said desktop being shared.

5. The system of claim 1 wherein said selected portion is consistent with less than the entire said desktop being share and not consistent with a window of said desktop being shared.

6. The system of claim 1 wherein said selected portion is shared with a first group of users and another selected portion is shared with a second group of users, wherein the first group of users is not the same as the second group of users.

7. The system of claim 1 wherein said selection portion includes a first layer of information upon which the user may annotate on a second layer, wherein the first layer and said second layer are different programs.
